(19) United States
(12) Patent Application Publication
(10) Pub. No.: US 2012/0180410 A1
(43) Pub. Date: Jul. 19, 2012

(54) INSULATION PANEL

(76) Inventors: PHILIP B. BARTHOLOMAY, Santa Barbara, CA (US); Erik D. Black, Santa Barbara, CA (US)

(21) Appl. No.: 13/009,815

(22) Filed: Jan. 19, 2011

(51) Int. Cl. E06B 3/28

(52) U.S. Cl. 52/203

(57) ABSTRACT

An insulation panel consisting of one or more panes of generally transparent material configured to span a window or other framed opening of a building structure.

The panel has a continuous border around the perimeter edges of one or both sides consisting of general transparent material protruding slightly from the panel for purposes of installation to the spanned opening.

The second embodiment of the insulation panel is to create an attachment to an existing window or other framed opening, by use of an adhesive and/or compressive seal, which may or may not be airtight.

The third embodiment of the insulation panel is to create a sound baffle or insulation effect through attachment to an existing window or framed opening similar to that of a double paned window.

The fourth embodiment of the insulation panel is to create a safety barrier against flying debris.

The fifth embodiment of the insulation panel is a prefabricated insulation panel consisting of two or more panels of generally transparent material with a continuous border around the perimeter edges of one or more of the panels joined together creating a separation between two of the panes of the insulation panel.

### TECHNICAL FIELD OF INVENTION

The present invention relates to insulation panels and more particularly to a generally transparent panel for use as a secondary pane for windows or other framed openings in buildings, creating after market retrofit dual or two paned windows.

### BACKGROUND ART

The prior art provides numerous window inserts for insulating an interior of a building from outside air. Some of these prior art window inserts include U.S. Pat. No. 4,462,186 to FULLER; U.S. Pat. No. 4,486,990 to BAUCH; U.S. Pat. No. 6,052,957 to MINNICH; and U.S. Pat. No. 7,818,927 to JOHN, for a removable window insulator with frame. The FULLER patent discloses a self-adjusting window unit with a corner assembly. The FULLER device permits continued adjustment of the frame while providing strength of the frame at the corners and maintains a fully insulated frame. The BAUCH patent discloses a removable window insulation system. The BAUCH device comprises a panel formed of a rigid foam insulation board dimensioned less than the interior casing dimensions of a window. The MINNICH patent discloses a compressible insert. The MINNICH device includes a sheet which is retained in an adjustable frame. However, to fully seal the compressible insert to the window frame, at least one fastener must be screwed through the adjustable frame into the window frame. The JOHN patent discloses a device which is a removable window insulator comprised of at least four attached frame members and at least four adjusting frame members attached horizontally and vertically with four compressible seals which is then fitted into a window frame. All of the prior art requires frames or attaching frames and frame members for support of the window and fasteners.

Accordingly, there is clearly felt a need in the art for a prefabricated, lightweight insulation panel with minimally protruding border around its perimeter edges, consisting of one piece, without any frame or frame members, that attaches either to an existing window and/or framed opening, simply by any mode of adhesion (without any adjusting frame and without any fasteners): as well as a need in the art of allowing two or more of the insulation panels to be joined together leaving an area of separation between two of the panels created by the protruding border(s) on the inner perimeter edges of one or more of the panels.

### SUMMARY OF INVENTION

The present invention is directed to an insulation panel adapted for installation into framed openings, including windows, in building structures. The panel includes either a single, or multiple, piece(s) of generally transparent material used to span framed openings in the building structure. The panel also includes a single minimally protruding border around its perimeter edges on one, or both, side(s) consisting of generally transparent material allowing the panel to attach to the framed opening by adhesion and/or compressive seal.

A second embodiment of the insulation panel is directed to the creation of an insulating barrier by attachment of the prefabricated panel secondarily to the existing window or framed opening; thereby impeding heat and cold transference.

A third embodiment of the insulation panel is directed to attach to the existing framed opening or window directly, and/or to the window frame to create an airtight seal between the existing window, or opening and prefabricated insulation panel.

A fourth embodiment of the insulation panel is directed to the creation of a sound barrier by attachment of the prefabricated insulation panel secondarily to the existing window or framed opening; thereby diffusing, cancelling, lessening, and/or baffling noise that might enter building structure.

A fifth embodiment of the insulation panel is directed to the insulation panel having texture, which includes specifically, but not exclusively, any one of the following, or combination of the following: Electro-chromatic coating, ultra violet protection, tinting, colonization, frosting, staining, stippling, crazing, mottling, etching, checkering, carving, engraving, corrugation, polarization, misting, airbrushing and/or painting.

A sixth embodiment of the insulation panel is directed to its mode of installation and/or attachment to existing window or framed opening, allowing it to be affixed either permanently or temporarily, as well as either sealed airtight or unsealed for airflow.

A seventh embodiment of the insulation panel is directed to the joining together of two or more of the panels with an air gap between the panels created by the protruding border(s) around the inner perimeter edges of one or more of the panels, which may either be sealed airtight or allow air circulation through manufactured openings in the panels.

The features, functions, and advantages can be achieved independently in various embodiments of the preset invention or may be combined in other embodiments.

### BRIEF DESCRIPTION OF DRAWINGS

FIG. 1—plan view of a typical insulation panel in accordance with the present invention.

FIG. 2—sectional view of a typical laminated insulation panel in accordance with the present invention.

FIG. 3—sectional view of a typical mold formed insulation panel in accordance with the present invention.

### DETAILED DESCRIPTION OF THE PREFERRED EMBODIMENT

The following description of the preferred embodiment(s) is merely exemplary in nature and is in no way intended to limit the invention, its application, or uses.

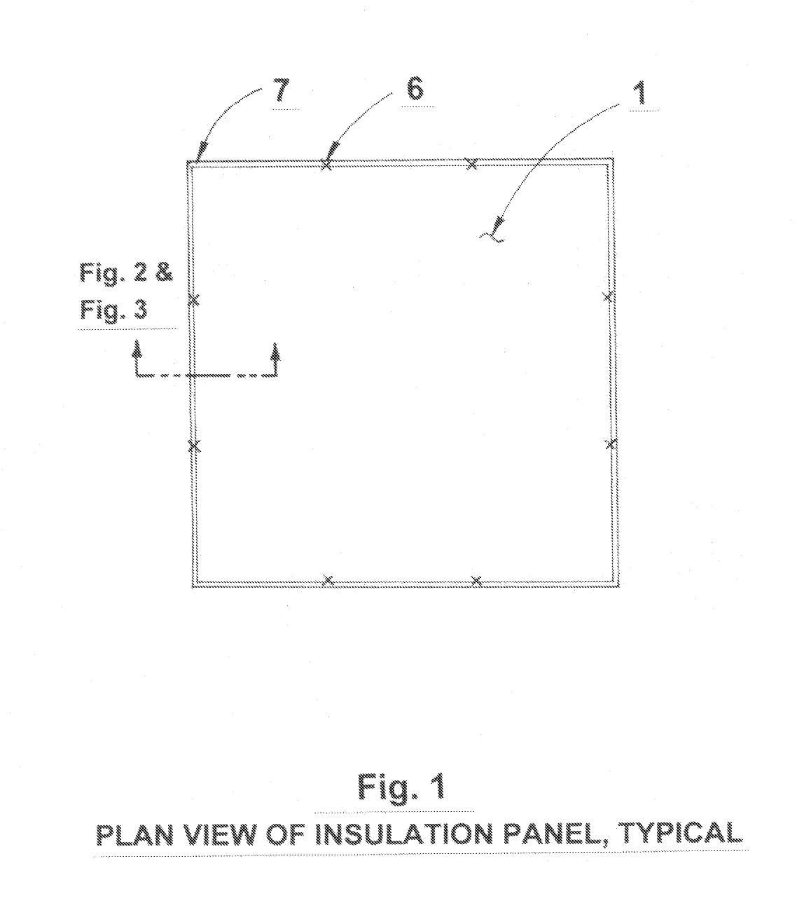

With reference now to the drawings, in particular FIG. 1, a plan view of the insulation panel. The insulation panel (1) preferably contains at least one pane, (2) a minimally protruding border around the perimeter edges of at least one side of the panel, (3) for attaching the insulation panel to an existing window or framed opening by adhesive, hook and loop (e.g. Velcro), removable glue strip, glue, gel, putty, or compression seal, or epoxy, if a seal is desired. However, other methods of sealing the panel to the existing window or frame can be used, or the panel may be attached without sealing it to allow airflow.

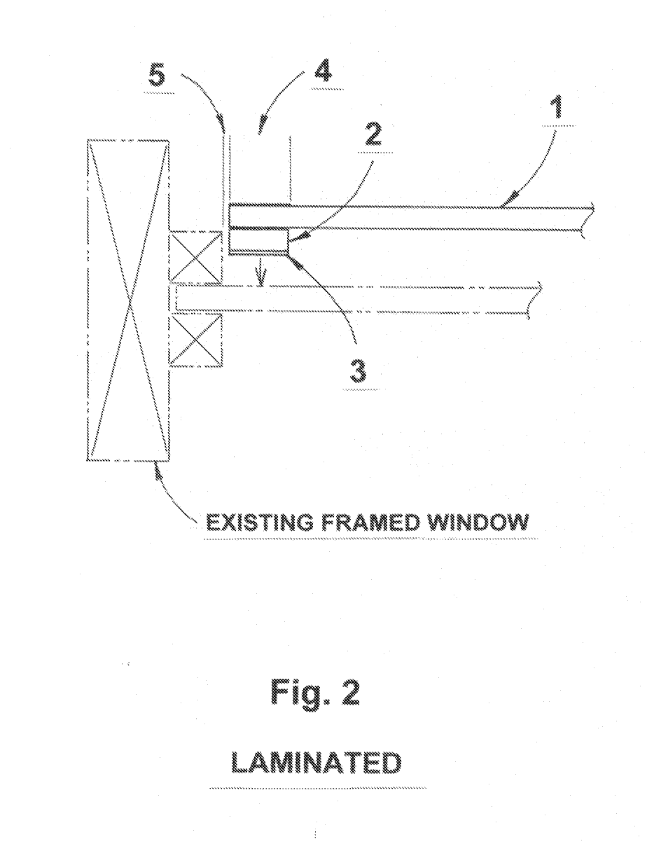

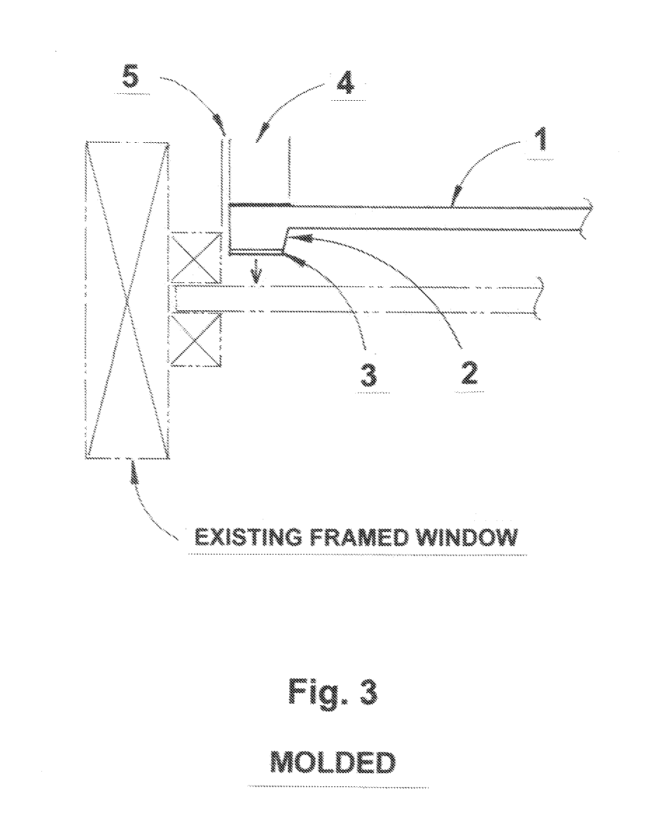

FIG. 1 is a visual depiction of the configuration of a typical transparent insulation panel 1 consisting of a continuously, narrow, slightly protruding border (shown as 2 on FIG. 2.) around the perimeter edges, which may or may not include a perpendicular or beveled angle (shown on FIG. 3.), creating a void in the field along the inside of the exposed edge of the protruding border, which is on one side of the panel. The other side of the panel is a flat, level, plane surface 1 (shown as 1 on FIG. 2.) of the insulation panel. The dimensional length, width, and thickness of the insulation panel may be standard industry size or custom sized depending on the span of the opening to be retrofitted or covered. An optional air ventilation opening 6 (FIG. 1.) duct, slot, hole or other opening, can be manufactured in the panel. The size, location and physical configuration of the optional air openings may be determined based on the manufacturing process or design. At a corner 7, a possible location for placement of a hook and loop fasten and release system, possibly recessed in a cavity at each corner, or at intervals, or consistently along the protruding border around the perimeter edges of the insulation panel (shown as 2. on FIG. 2.), to create a bond when attached to an existing window pane, framed opening, or similar opening.

With reference to the drawings, in particular FIG. 2 and FIG. 3, the insulation panel may be fabricated utilizing, but is not limited to, the following procedures: injection molding, lamination, form molding, blow molding, extruding, die casting, forging, sculpting or chiseling, consisting of specifically, but not exclusively, polymeric materials, e.g. poly-carbonate, or acrylic, polyurethane, Plexiglas, plastic, vinyl, glass, fiberglass, Pyrex, porcelain, ceramic, catalyst, or resin.

FIG. 2 is a visual depiction of a configuration of a typical laminated transparent insulation panel 1. FIG. 3 is a visual depiction of a configuration of a typical form molded type transparent insulation panel 1.

With reference to both FIG. 2 and FIG. 3, the slightly protruding border around the perimeter edges, which may or may not include a perpendicular or beveled edge (shown in FIG. 3.), creates a void along the inside exposed edge of the protruding border in the field along one side of the panel 1. A possible peel away cover strip or tape 3 which may be used on the protruding border 2 which, when the tape/strip is removed, would expose a clear adhesive, glue type substance for the purpose of attaching the insulation panel to an existing window or other opening. On the other side of the panel 1 directly across from the protruding border 2 is an area where an optional surface concealment 4 can be placed, such as frosting, staining, stippling, crazing, mottling, etching, checkering, carving, engraving, corrugation, misting, etc. The minimal perimeter clearance required for the installation of the insulation panel and/or removal of the laminated insulation panel 5 as depicted on FIG. 2. and FIG. 3.

However, other methods of fabrication and materials, e.g. nanotechnology, for manufacturing the insulation panel may be used or developed.

Embodiments of the foregoing insulation panel make it possible to simply and inexpensively, create a double window pane sub-assembly for retrofitted attachment to existing single pane windows in a structure. Instead of replacing existing single pane windows with new dual or two pane windows, one can take the prefabricated, light weight, polymer based insulation panel of standard sizes in the industry, or customized size, and install or attach it to the existing window, or framed opening, by its protruding border around its perimeter edges by using any appropriate adhesive process; liquid, glue, gel, putty, epoxy, hook and loop fastener, or otherwise; thereby creating a sound baffling and insulation effect that can be either sealed, or not, as well as be either permanent or removable.

A further embodiment is the combining together of two or more insulation panels with the protruding border(s) around the inner perimeter edges of one or more panel creating an area of separation between the panels, which can be either sealed airtight or allowing air circulation.

These panels significantly reduce labor and fabrication costs. The configurations can provide low cost insulation panels that are lighter due to not having a frame or frame members. Insulation panels configured in accordance with the principals of the present invention can consist of one or more panes, do not require attached frames or frame members for support, and can provide essentially double window properties at a fraction of the cost.

While the various preferred embodiments have been described, those skilled in the art will recognize modifications or variations which might be made without departing from the inventive concept. The examples illustrate the invention and are not intended to limit it. Therefore, the description should be interpreted liberally with only such limitations as necessary in view of the pertinent prior art.

### INDUSTRIAL APPLICABILITY OF INVENTION

Most building structures, at least older ones, have single paned windows. There is a need for simple after market pre-fabricated insulation panels which can be easily installed and attached secondarily to existing single paned windows, thereby creating an insulated and/or sound baffling effect.

Such secondary insulation panels may be either permanent and/or removable depending on mode of installation.

The invention also encompasses the joining together of two or more of the insulation panels with the border(s) around the inner perimeter edges of one or more of the panels creating a separate air space between two or more of the panels, which may either be sealed or allow air circulation through manufactured openings in the panels.

1. An insulation panel consisting of one piece of generally transparent material with slightly protruding border around its perimeter edges, of generally transparent material,
each insulation panel having a shape and size to span existing windows or other framed openings in a building structure,
each insulation panel having a shape and size for lining existing windows or other framed openings in a building structure,
each insulation panel having a protruding border around its perimeter edges configured to fit substantially flush with existing windows or other framed openings,
each insulation panel's protruding border around its perimeter edges configured to be secured to the existing windows by adhesion mode,
each insulation panel's protruding border around its perimeter edges configured to be secured to the existing framed opening by adhesion mode.

2. An insulation panel of claim 1, further comprising a plurality of panes of generally transparent material.

3. An insulation panel of claim 1, further comprising a border around its perimeter edges of generally transparent material on one side for affixing a panel to an existing window or framed opening.

4. An insulation panel of claim 1, further comprising a border around its perimeter edges of generally transparent material on both sides of the panel for affixing to an existing window or framed opening.

5. An insulation panel of claim 1, further comprising a border around its perimeter edges of generally transparent material on one side of the panel for affixing to an existing framed opening.

6. An insulation panel of claim 1, further comprising a border around its perimeter edges of generally transparent material on both sides of the panel for affixing to an existing framed opening.

7. An insulation panel of claim 1, further comprising a border around its perimeter edges of generally transparent material for adhesion to an existing window and/or framed opening to create an airtight seal.

8. An insulation panel of claim 1, further comprising a border around its perimeter edges of generally transparent material for adhesion to an existing window or framed opening to create an area between the panel and existing structure for air circulation.

9. An insulation panel of claim 1, further comprising the joining together of two or more of the panels with the protruding borders around the inner perimeter edges of one or more of the panels creating an area of separation between the panels which can be sealed airtight.

10. An insulation panel of claim 1, further comprising the joining together of two or more of the panels with the protruding borders around the inner perimeter edges of one or more of the panels which can allow air circulation through manufactured openings consisting of holes and/or slots.

11. An insulation panel of claim 1, further comprising texture, including specifically, but not exclusively, electro chromatic coating, ultra violet protection, tinting, colorization, frosting, staining, stippling, crazing, mottling, etching, checkering, carving, engraving, corrugation, polarization, misting, airbrushing and/or painting.

12. An insulation panel of claim 1, further comprising being affixed permanently to an existing window or framed opening.

13. An insulation panel of claim 1, further comprising the ability to be affixed temporarily to an existing window, and/or framed opening, and be removable.

14. An insulation panel of claim 1, further comprising a customized shape, and/or size, to span existing window or other framed opening in a building structure.

15. An insulation panel of claim 1, further comprising of a safety barrier against flying debris or objects.

16. An insulation panel of claim 1, further comprising a standard shape, and/or size, in the industry to span existing window or other framed opening in a building structure.

17. An insulation panel of claim 1, further compromising a sub-assembly for retrofit attachment to existing window or other framed opening in a building structure.
